(19) United States
(12) Patent Application Publication
(10) Pub. No.: US 2004/0234931 A1
(43) Pub. Date: Nov. 25, 2004

(54) Printed publication system with information indication

(76) Inventor: Maggie Yuk-Fung Poon, Hong Kong (CN)

Correspondence Address: BURNS, DOANE, SWECKER & MATHIS, L.L.P., P.O. Box 1404, Alexandria, VA, 22313-1404, US

(21) Appl. No.: 10/442,936

(22) Filed: May 22, 2003

(51) Int. Cl. G09B 11/08

(52) U.S. Cl. 434/158

(57) ABSTRACT

Printed publications capable of interacting with the reader require information, particularly page number, detection. One method is to attach a bar code made of reflective and non-reflective materials onto each page to deliver the page number by reflection. This method may be easily affected by several factors, including the direction of the light source, or even being totally blocked by other objects like the hand of a reader. This invention provides an improved printed publication having at least one opening on each page that substantially coincides with the openings in adjacent pages. An information indicator on each of the pages delivers a signal through these openings to indicate the open configuration or the page number.

### FIELD OF THE INVENTION

This invention relates to printed publication systems capable of interacting with the reader and in particular, but not necessarily solely, publications having interactive mechanisms such as talking books.

### BACKGROUND OF THE INVENTION

Printed publications capable of interacting with the reader are generally desirable, as such systems can raise the reader's interest, particularly young children. The interaction may be provided by displaying a relevant message when the printed publication, for example, a book, is opened to a particular page. The message can be, for example, the dialogue in a novel, footnote, or even as simply as the page number. To achieve this purpose, it is necessary to provide some mechanism to detect the page number when the book is opened to a particular page.

U.S. Pat. No. 4,884,974 describes one of such page recognizing mechanism utilizing a bar code attached to each page. The bar code is formed by a plurality of light reflective and non-reflective elements to provide signals for identifying the page in concern. When the book is opened to a particular page, light reflected by the reflective and non-reflective materials of the bar code provides a signal to be read by a corresponding sensor. The bar code is in the form of a binary number representing a corresponding page number. However, this approach may not be reliable as the reflection from the bar code may be affected by several factors, including the direction of the light source, or even being totally blocked by other objects like the hand of a reader. Further, as the signal from the bar code is generated by reflection, only binary signals can be delivered by the bar code.

### OBJECTS OF THE INVENTION

Therefore, it is an object of this invention to resolve at least one or more of the problems as set forth in the prior art. As a minimum, it is an object of this invention to provide the public with a useful choice.

### SUMMARY OF THE INVENTION

Accordingly, this invention provides a printed publication system including a printed publication. The printed publication includes a plurality of pages, wherein each page substantially overlies adjacent pages in a closed configuration; and two of said pages at least partially do not overlay in a corresponding open configuration. There is at least one opening on each of said pages for which information is to be indicated, wherein the opening on one page substantially coincides with the openings in remaining unopened pages in the open configuration. An information indicator is provided on each of said pages for which information is to be indicated, each information indicator being readable through said openings in said remaining unopened pages when in said open configuration, to indicate said open configuration.

Optionally, the printed publication system of this invention further includes an information detector including at least one sensor to be positioned at least adjacent to said openings for detecting the signal. Preferably, the sensors are dipped into said openings.

Preferably, the signal is a plurality of light signals delivered by a corresponding plurality of information indicators, and the information detector has a plurality of corresponding sensors. More preferably, the plurality of corresponding sensors include a plurality of corresponding light-emitting elements, and the light signals are delivered by the corresponding plurality of information indicators by reflection. Optionally, the plurality of corresponding sensors include a plurality of corresponding light-emitting elements, and the light signals are delivered by the corresponding plurality of information indicators by fluorescence. Alternatively, the light signals are emitted by the corresponding plurality of information indicator.

Preferably, each information indicator is attached to each page by a foldable attachment, said foldable attachment is folded in the closed configuration and extended to position the information indicator over the coinciding openings in the open configuration.

This invention also provides a printed publication including;

a plurality of pages, wherein each page substantially overlies adjacent pages in a closed configuration; and two of said pages at least partially do not overlay in a corresponding open configuration;

at least one opening on each of said pages, wherein the opening on one page substantially coincides with the openings in remaining unopened pages in the open configuration; and

an information indicator on each of said pages, each information indicator being readable through said openings in said remaining unopened pages when in said open configuration, to indicate said open configuration.

It is another aspect of this invention to provide a method of manufacturing a printed publication including a plurality of pages, wherein each page substantially coincides with adjacent pages in a closed configuration; and two of said pages are opened in a corresponding open configuration, said method including the steps of:

generating at least one opening on each of said pages, wherein the opening on one page substantially coincides with the openings in adjacent pages in the open configuration;

attaching an information indicator to each of said pages, each information indicator delivering a signal through said openings in said open configuration to indicate said open configuration.

Yet another aspect of this invention provides a printed publication system including:

a printed publication including:

a plurality of pages, wherein each page substantially overlies adjacent pages in a closed configuration; and two of said pages at least partially do not overlay in a corresponding open configuration;

information indicators on each of said pages for which information is to be indicated, each information indicator representing a binary number to indicate said open configuration, wherein said information indicator is formed by a plurality of conductive materials each representing a positive bit of said binary number.

an information detector capable of detecting conductive material including at least one sensor to be positioned in proximity to said information indicators for detecting the signal.

### BRIEF DESCRIPTION OF THE DRAWINGS

Preferred embodiments of the present invention will now be explained by way of example and with reference to the accompany drawings in which:

FIG. 1 shows a printed publication system of this invention including a printed publication and the corresponding information detector in a closed configuration;

FIG. 2 shows the printed publication of FIG. 1 in the open configuration;

FIG. 3 shows one example of the information indicator used in this invention; and

FIG. 4 shows another example of the information indicator of this invention.

### DETAILED DESCRIPTION OF THE PREFERRED EMBODIMENT

This invention is now described by ways of example with reference to the figures in the following paragraphs. List 1 is a part list so that the reference numerals in the figures may be easily referred to.

Objects, features, and aspects of the present invention are disclosed in or are obvious from the following description. It is to be understood by one of ordinary skill in the art that the present discussion is a description of exemplary embodiments only, and is not intended as limiting the broader aspects of the present invention, which broader aspects are embodied in the exemplary constructions.

The word “printed publication” used in this application refers to books, magazine, newspaper, or generally, document in which information or stories are published. This may also include blank photo-album for storing photos.

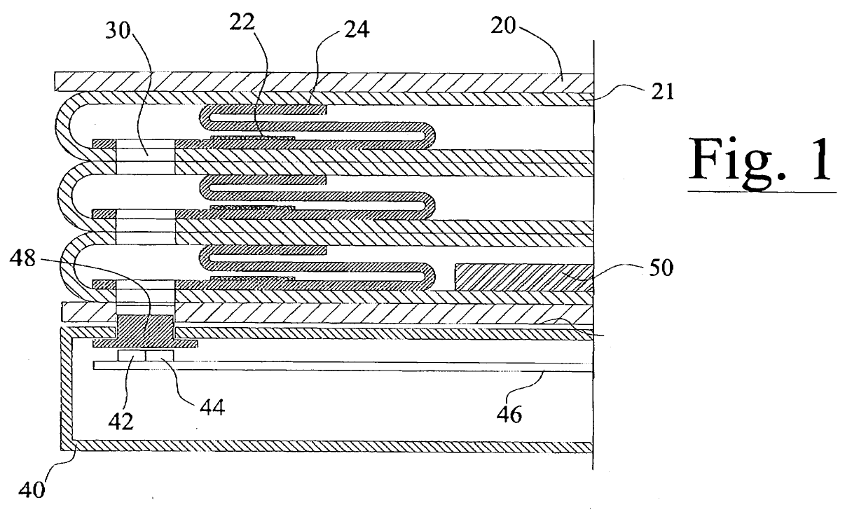

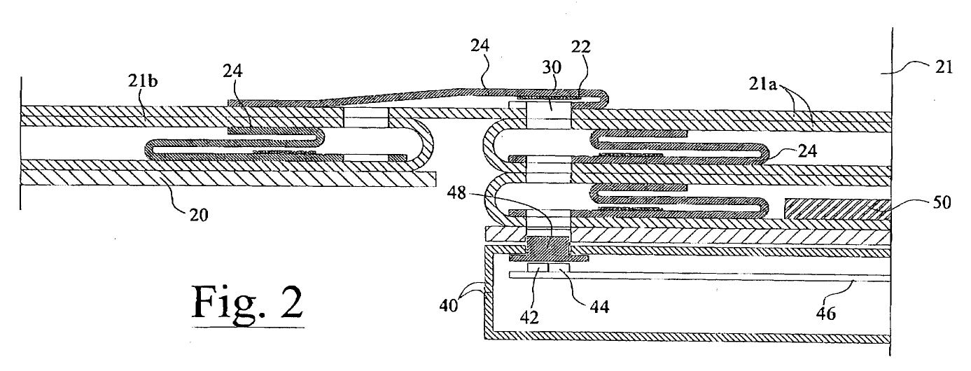

FIG. 1 shows a cross section of the printed publication system 10 of this invention, which includes a printed publication 20, and optionally an information detector 40. The printed publication 20 includes a plurality of pages 21, and each page 21 substantially coincides with adjacent pages in the closed configuration as shown in FIG. 1. When the printed publication 20 is opened as shown in FIG. 2, two of the pages 21 are opened in the open configuration to open pages 21a and 21b.

As shown in FIG. 2, each page 21 for which information is to be indicated has at least one opening 30 substantially coinciding with the openings 30 in adjacent pages in the open configuration. Such openings are preferably coinciding with each other in the closed configuration, although this may not be necessary. The number of openings on each page is to be determined by the total number of pages in the printed publication 20 and/or, more importantly, the nature of the light signals to be emitted by the information indicator, which will be detailed below. The openings 30 may be generated by any suitable methods like cutting, piercing, punching, blanking or the like.

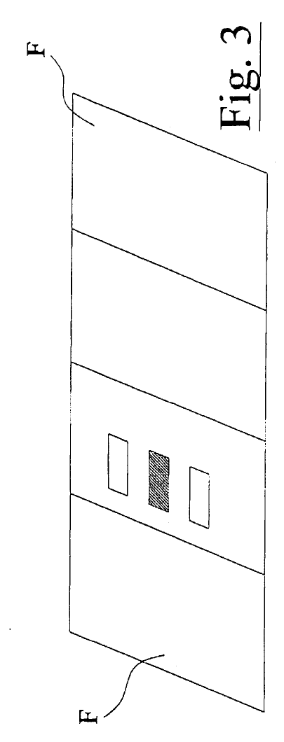

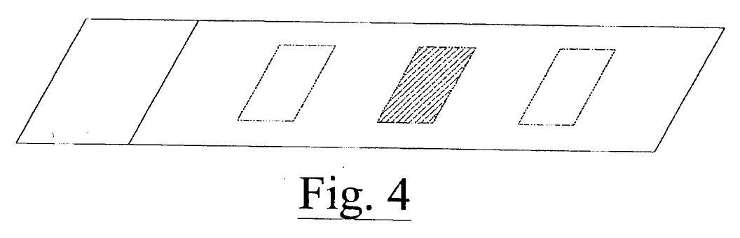

Each Page 21 also has an information indicator 22 responsible for delivering light signals through the coinciding openings 30. The information indicator 22 may be attached to each page 21 by a foldable attachment 24, which is folded in the closed configuration and extended to position the information indicator 22 over the coinciding openings 30 in the open configuration. It shall be appreciated that variations in the attachment of the information indicator 22 to the pages 21 are possible. For example, as shown in FIG. 3, the bar code is on a piece of attachment having three folding lines. The attachment is attached to the printed publication on regions marked “F” on two different pages. Alternatively, the attachment can be in the form as shown in FIG. 4, in which the attachment has only one folding line. According to such a construction, only one information indicator 22 can be detected through the coinciding openings 30 at one time. Although FIG. 2 shows only one information indicator 22 to be detected through the coinciding openings 30 from one of the open pages 21a, it shall be understood that an additional information indicator can be detected from the other open page 21b, if desired.

It is possible that, for example, only pages 6 to 10 of a 10-page book may contain the information indicators 22. In such a case, only pages 6 to 10 may have the openings 30 and the information indicators 22. The openings 30 and the information indicators 22 may be excluded from pages 1 to 5 in such an example.

In the above example, the information indicators 22 are not readable through the coinciding openings 30 in the closed position. A corresponding information indicator 22 is positioned over the coinciding openings 30, preferably by the foldable attachment 24, when the book 20 is opened. It shall be understood by a person skilled in the art that the reverse may be true. For example, the information indicators 22 may now be positioned over the coinciding openings 30 in the closed configuration. When the book 20 is opened, the foldable attachment 24 now removes the corresponding information indicator 22 away from the coinciding openings 30, which is then unreadable. Accordingly, the next information indicator 22 is shown. Of course, the information, for example the page number, contained in the information indicators 22 has to be adjusted.

There may be a number of different constructions for the information indicator 22. For example, the information indicator 22 can be written numerals indicating the page number. The corresponding information detector can be a specially designed scanner capable of recognizing such numerals. This may increase the overall costs and complexity and may not be particularly preferred. On the other hand, the information detector 40 may not be necessary in this case.

In a preferred embodiment of this invention, each information indicator 22 is a bar code formed by, for example, a series of light reflective and non-reflective materials as in U.S. Pat. NO. 4,884,974. Accordingly, a plurality of openings 30 will be required on each page 21, and the information indicator will also have a plurality of corresponding detectors. As shown in FIG. 1, each sensor of the information detector 40 may have a light emitting element 42 and a light-sensing element 44, such that a binary light signal is detected by each sensor. The light emitting element 42 and a light-sensing element 44 may be optionally protected by a protective element 48. The signals received by the information detector 40 can then be interpreted by the circuit board 46 implementing an algorithm similar to that disclosed in U.S. Pat. No. 4,788,974. As a result, a binary number can be detected by the information detector 40 which can then be used to indicate the open configuration of the printed publication 20.

Alternatively, the bar code may be formed by a series of fluorescent and non-fluorescent materials. In such a case, the light-emitting element 42 is responsible for exciting the fluorescent materials.

Suitable examples of the bar codes are shown in FIGS. 3 & 4. The bar code shown in FIG. 3 is arranged in a vertical configuration, while that in FIG. 4 is arranged in a horizontal manner. It can be realized that the orientation of the bar codes may not be importantly. Of course, the corresponding information detector 40 may have to be modified accordingly.

Although the sensor can be positioned relatively distantly from the openings 30, it is preferred to have the sensor “dipped” into the openings 30 when in use to enhance accuracy. In this context, the word “dipped” refers to the situation as shown in FIGS. 1 and 2, in which the sensor 44 is put briefly into the opening 30, which may or may not penetrate through several openings 30 vertically. Further, this can reduce the power required for lighting the reflective material or exciting the fluorescent material. Therefore, it may be preferable to attach the information detector 40 to the printed publication 20 by, for example, a clip 50.

Yet another example is to have the reflective material replaced by light emitting element, for example light emitting diode.

Other implementations are possible, although they may not be considered commercially at present due to high implementation costs. For instance, each region of the reflective or fluorescent material mentioned above may be a bar code itself. Much more information can be stored in such a way. However, higher costs will be required as the information detector 40 will have to be more complex.

As stated before, the information detector 40 may display various information after detecting the corresponding information indicator 22, including page numbers, dialogue in a novel, or some special notes. The information can be contained in an optionally removable cartridge in the information detector 40. The detailed construction or mechanism of such information storage systems is known to a person skilled in the art.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. A printed publication system including:
a printed publication including:
a plurality of pages, wherein each page substantially overlies adjacent pages in a closed configuration; and two of said pages at least partially do not overlay in a corresponding open configuration;
at least one opening on each of said pages for which information is to be indicated, wherein the opening on one page substantially coincides with the openings in remaining unopened pages in the open configuration; and
an information indicator on each of said pages for which information is to be indicated., each information indicator being readable through said openings in said remaining unopened pages when in said open configuration, to indicate said open configuration.

2. The printed publication system of claim 1 further including
an information detector including at least one sensor to be positioned at least adjacent to said openings for detecting the signal.

3. The printed publication system of claim 2, wherein the sensors are dipped into said openings.

4. The printed publication system of claim 2, wherein the signal is a plurality of light signals delivered by a corresponding plurality of information indicators, and the information detector has a plurality of corresponding sensors.

5. The printed publication system of claim 4, wherein the plurality of corresponding sensors include a plurality of corresponding light-emitting elements, and the light signals are delivered by the corresponding plurality of information indicators by reflection.

6. The printed publication system of claim 4, wherein the plurality of corresponding sensors include a plurality of corresponding light-emitting elements, and the light signals are delivered by the corresponding plurality of information indicators by fluorescence.

7. The printed publication system of claim 4, wherein the light signals are emitted by the corresponding plurality of information indicator.

8. The printed publication system of claim 1, wherein each information indicator is attached to each page by a foldable attachment, said foldable attachment is folded in the closed configuration and extended to position the information indicator over the coinciding openings in the open configuration.

9. A printed publication including:
a plurality of pages, wherein each page substantially overlies adjacent pages in a closed configuration; and two of said pages at least partially do not overlay in a corresponding open configuration;
at least one opening on each of said pages for which information is to be indicated, wherein the opening on one page substantially coincides with the openings in remaining unopened pages in the open configuration; and
an information indicator on each of said pages for which information is to be indicated, each information indicator being readable through said openings in said remaining unopened pages when in said open configuration, to indicate said open configuration.

10. The printed publication of claim 9, wherein the signal is a plurality of light signals delivered by a corresponding plurality of information indicators.

11. The printed publication of claim 10, wherein the light signals are delivered by reflection.

12. The printed publication of claim 10, wherein the light signals are delivered by fluorescence.

13. The printed publication of claim 10, wherein the light signals are emitted by the corresponding plurality of information indicator.

14. The printed publication system of claim 9, wherein each information indicator is attached to each page by a foldable attachment, said foldable attachment is folded in the closed configuration and extended to position the information indicator over the coinciding openings in the open configuration.

15. A method of manufacturing a printed publication including a plurality of pages, wherein each page substantially coincides with adjacent pages in a closed configuration; and two of said pages are opened in a corresponding open configuration, said method including the steps of:
generating at least one opening on each of said pages for which information is to be indicated, wherein the opening on one page substantially coincides with the openings in adjacent pages in the open configuration;
attaching an information indicator to each of said pages for which information is to be indicated, each information indicator delivering a signal through said openings in said open configuration to indicate said open configuration.

16. The method as claimed in claim 15, wherein each information indicator is attached to each page by a foldable attachment, said foldable attachment is folded in the closed configuration and extended to position the information indicator over the coinciding openings in the open configuration.

17. A printed publication system including:
a printed publication including:
a plurality of pages, wherein each page substantially overlies adjacent pages in a closed configuration; and two of said pages at least partially do not overlay in a corresponding open configuration;
information indicators on each of said pages for which information is to be indicated, each information indicator representing a binary number to indicate said open configuration, wherein said information indicator is formed by a plurality of conductive materials each representing a positive bit of said binary number.
an information detector capable of detecting conductive material including at least one sensor to be positioned in proximity to said information indicators for detecting the signal.
